(19) United States
(12) Patent Application Publication
(10) Pub. No.: US 2014/0102312 A1
(43) Pub. Date: Apr. 17, 2014

(54) Popcorn Making Machine with Corn Intake Control

(71) Applicant: Mikhail Korin, Moscow (RU)

(72) Inventor: Mikhail Korin, Moscow (RU)

(21) Appl. No.: 13/653,568

(22) Filed: Oct. 17, 2012

(51) Int. Cl. A23L 1/18

(52) U.S. Cl. 99/323.9

(57) ABSTRACT

A popcorn making machine includes a case enclosing a roaster with a circulated hot airflow therein, causing raw corn to pop up, a feeding pipe having an upper aperture for feeding raw corn thereinto and a lower aperture, and a trap mounted within the case. The trap has an upper entrance for receiving raw corn and a lower exit for discharging thereof into the roaster. The upper entrance is coupled with the lower aperture. The trap includes a body, having inner walls, and at least two blades attached to the inner walls on opposite sides thereof, and inwardly declined. A lower blade is inwardly protruded from the inner wall, so that it partially covers the lower exit. The trap prevents blocking the feeding pipe by corn kernels that otherwise would be capable of getting into and blocking thereof, thereby enhancing the machine's reliability and maintainability. Preferable trap dimensions are provided.

### FIELD OF THE INVENTION

This invention relates to corn popping machines, particularly to popcorn preparation machines utilizing the continuous popping of corn kernels by means of a hot airflow.

### BACKGROUND OF THE INVENTION

There are known a variety of devices for popcorn processing, for example, the one taught in U.S. Pat. No. 7,024,986 that describes “a popcorn maker including a self-regulating heating unit. The self-regulating heating unit provides a regulated heat to the popcorn maker. The self-regulating heating unit can be configured to maintain a predetermined temperature for the popcorn maker. The predetermined temperature can be adjusted to provide appropriate amount of heat to the popcorn maker for popping a maximum number of corn kernels while limiting the heat from causing damage to heating coils and thermoplastic parts of the popcorn maker. The self-regulating heating unit includes a positive temperature coefficient heater.”

Another U.S. Pat. No. 5,421,253 teaches a ‘convection oven corn popper and method’ that “. . . is provided to air-pop popcorn in combination with a convection-type oven. The device comprises a spring-mounted bowl to hold corn kernels and includes a slot in the sidewall for popped popcorn to exit therefrom. The exiting popcorn falls into the cooking case of the oven where it is held warm until ready to eat.”

“A portable heat-concentrating kettle cooker” is taught in U.S. Pat. No. 6,234,064, in particular, having “a housing with a burner supported within the housing and a kettle carrier pivotably attached to a top edge of the housing such that it can be pivoted from a substantially horizontal position across the top of the housing to a substantially vertical position. The kettle carrier includes a cooking kettle that is positioned over the burner when the kettle carrier is in its substantially horizontal position, and when the kettle carrier is in its substantially vertical position, the cooker kettle is positioned to empty its contents into a tub that is supported next to the housing by a detachable frame extending from the housing. Additional features of the cooker include a heat intensification case formed by a wall around the burner in order to redirect radiant energy from the burner back into the heat intensification case. A cooking oil receptacle is also detachably mounted to the housing. Fuel supplied to the heater can be natural gas, propane, or electricity, with fuel supply lines passing through a fuel supply/control case at the front of the housing and fuel regulating controls positioned on the front of the housing.”

U.S. Pat. No. 6,187,353 to Wyman et al teaches “a hot air popcorn machine including a programmable control system for precisely controlling various operating parameters including air flow and air temperature to enable the machine to consistently produce high quality popcorn in a low maintenance environment, e.g., a free-standing vending machine.” In Wyman's machine, hot airflow comes through the kernels and exits the cooking case, i.e. the hot airflow is not confined in the machine. This leads to over-drying popcorn and overpaying for electric power.

U.S. Pat. No. 6,460,451 to Helman et al discloses “A popcorn maker, which utilizes a combination of popping means, and converts corn kernels to popped corn quicker, more efficiently, and with improved taste. The popcorn maker uses a combination of roasting, agitation, heating, and convection to convert the corn kernels into the popcorn, and expel the popcorn out of the popcorn maker. The popcorn maker is easy to use, the corn kernels and the popcorn easily viewable and fun to watch during popping, the popcorn maker producing the popcorn in a quick, convenient, and efficient manner. The popcorn maker discharges the popcorn from a convenient discharge chute into a receptacle of choice, resembles, and has the appearance of an old fashioned popcorn maker. The popcorn maker is free standing, easy to clean and maintain, and of long lasting, durable material. The popcorn maker is light weight, inexpensive, safe to use, attractive, sturdy, of simple construction., and is easy to store.” In Helman's popcorn maker, hot airflow also comes through the kernels and exits the roaster, i.e. the hot airflow is not confined in the machine. This leads to over-drying popcorn and overpaying for electric power.

U.S. Pat. No. 4,727,798 issued to Nakamura (herein further called ‘Nakamura’) discloses a “popcorn processing machine has a heating case into which a measured quantity of raw corn kernels are fed in each operational cycle to be heated, agitated, and thus popped by only a hot air supplied under pressure as a whirling rising vortex, without the use of an oil, whereby greatly expanded puffs of popcorn of uniform quality are produced in a high yield and in a short processing time. The bottom of the heating case can be opened by a simple mechanism, whereby the popped popcorn product can be quickly dumped and the case bottom rapidly reclosed, the operational cycle time thereby being extremely short.”

Designers of popcorn making machines often encounter a common problem particularly described in Nakamura: “In a typical popcorn processing machine known heretofore, a receiving dish or pan into which corn kernels are charged is provided above a heat source. At the bottom of this pan, agitator vanes for rotating along the upper surface of the pan bottom are fixedly supported on a vertical shaft. Accordingly, when the vertical shaft is rotated, the vanes rotate within the pan thereby to agitate the raw corn kernels as they are heated by the heat source, whereby the corn kernels are heated and popped into expanded state to fill the interior of the pan. In such a machine, oil is ordinarily placed in the pan in order to cause the raw corn kernels to pop rapidly. As a consequence of the agitation of the corn kernels, this oil tends to be scattered together with minute particles of the corn against the inner surface of a transparent cover installed for observation around the sides of the pan. The oil and corn particles thus adhere to the glass cover, thereby dirtying the glass and causing it to become opaque. Furthermore, if these contaminants are left in adhering state, they will attract undesirable insects such as cockroaches and are therefore very unhygienic. Since an opaque condition of the glass cover prevents or obstructs observation of the corn popping progress, the contaminants must be frequently wiped off by hand, which is an inconvenient task. However, if oil is not used in order to prevent this contamination, the time for popping the raw corn becomes disadvantageously long. Furthermore, the construction of the machine itself in this case has been complicated because of the necessity of providing rotational support means and driving means for the agitator vanes.”

As shown above, Nakamura solves this problem by supplying “a hot air supplied under pressure as a whirling rising vortex, without the use of an oil” into the heating case with an openable bottom for popping. Thereafter, “the popped popcorn product can be quickly dumped and the case bottom rapidly reclosed, the operational cycle time thereby being extremely short.” However, the “whirling rising vortex” conditions an increased density of kernels in the lower central region of the case, wherein the speed of kernels and temperature of hot air are essentially minimal, which leads to uneven heating the kernels located in this region that slows down the overall heating of corn kernels in the case thereby decelerating the whole process of popcorn preparation. Besides, the movable bottom of the heating case reduces the overall reliability and maintainability of the Nakamura's machine.

The aforementioned shortage of Nakamura's machine was addressed in U.S. patent application Ser. No. 12/592,106 filed on 18 Nov. 2009 by Mikhail Korin, the instant inventor, now U.S. Pat. No. 8,276,504 issued on 2 Oct. 2012 titled “Hot-air popcorn machine especially with a seasoning coater”, whose disclosure is incorporated herein in its entirety by reference. U.S. Pat. No. 8,276,504 particularly teaches “A popcorn making machine includes a main unit comprising a fan pumping air into a case, enclosing a heater and a bowl. The bowl has sidewalls tapered downwardly with mini-nozzles attached thereto. Hot airflows are introduced from the case through the mini-nozzles into the bowl tangentially to its inner surface, forming a main hot airflow circulation. A central nozzle is mounted at the bowl's bottom, including slots, introducing additional airflows, tangential to the nozzle's surface, from the case into the bowl, forming an additional hot airflow circulation surrounding the nozzle, co-directed with the main circulation . . . ” According to U.S. Pat. No. . . ., the popcorn machine also comprises a feeding pipe through which raw corn is supplied into the bowl. This popcorn making machine is advantageous, since it provides a circulated hot airflow confined within the cooking case, which improves the popcorn preparation process and recycles heat. Nonetheless, exploitation and maintenance of the popcorn machine according to U.S. Pat. No. 8,276,504 have revealed certain inconveniences.

Inside the bowl, popcorn kernels fly significantly fast, possessing high kinetic energy, and can deflect from the bowl's bottom and sidewalls several times until they will pop up and acquire a sufficient volume to slow down their flight. Since popcorn kernels, contained in the bowl, pop up chaotically, a trajectory of popcorn kernels at the moment of their popup cannot be predicted. This leads to some kernels, which have been popped up or not popped up yet, getting into the feeding pipe, thereby blocking further intake of raw popcorn kernels from the feeding pipe and further preventing normal operation of the machine.

### BRIEF SUMMARY OF THE INVENTION

A primary aim of the claimed invention is to provide a simply designed hot-air popcorn making machine, enabling a fast and essentially even heating of corn kernels for efficient popping up thereof, and, at the same time, solving the above-described problem of blocking further intake of raw popcorn kernels.

Another aim of the claimed invention is to enhance the overall reliability and maintainability of the popcorn machine taught in to U.S. Pat. No. 8,276,504.

Another aim of the claimed invention is to utilize optional embodiments of the popcorn making machine, according to U.S. Pat. No. 8,276,504, including the employment of a coater unit for coating the popped corn with oil, salt, etc.

Other aims and particular applications of the claimed invention may become apparent to one skilled in the art upon learning the present disclosure.

These aims are achieved by providing an inventive popcorn making machine, which is disclosed herein below. In preferred embodiments, the popcorn making machine includes a main unit that comprises a case, enclosing a roaster with a circulated hot airflow therein, causing raw corn to pop up; a feeding pipe having an upper aperture for feeding raw corn into the popcorn making machine, and a lower aperture; and a trap mounted in a top region of the case. The trap has an upper entrance for receiving raw corn from the feeding pipe, and a lower exit for discharging raw corn into the roaster. The upper entrance of the trap is coupled with the lower aperture of the feeding pipe. The trap includes a body, having inner walls, and at least two blades attached to the inner walls on opposite sides thereof, and inwardly declined. The at least two blades include a lower blade inwardly protruded from the inner wall, so that it partially covers the lower exit. The trap prevents blocking the feeding pipe by corn kernels that otherwise would be capable of getting into and blocking thereof. A preferable shape of the lower exit and preferable dimensions of the trap are provided herein. The main unit also comprises conditional elements, such as a fan, a heater, a pipebranch, a transparent window, etc. Optionally, the main unit can be combined with a coater unit described in U.S. Pat. No. 8,276,504.

### BRIEF DESCRIPTION OF DRAWINGS

FIG. 1 shows a sectional front view of an embodiment of the popcorn making machine, according the claimed invention.

FIG. 2 shows a sectional view of the embodiment of the popcorn making machine, according the claimed invention, along a section A-A shown on FIG. 1.

FIG. 3 shows schematic lateral and plan views of a preferred embodiment of the trap coupled with a feeding pipe of the popcorn making machine, according to the claimed invention.

FIG. 4 shows a perspective front view of a preferred embodiment of the trap coupled with a feeding pipe of the popcorn making machine, according to the claimed invention.

FIG. 5 shows a perspective lateral view a preferred embodiment of the trap of the popcorn making machine, according to the claimed invention.

### DETAIL DESCRIPTION OF PREFERRED EMBODIMENTS OF THE INVENTION

While the invention may be susceptible to embodiment in different forms, there are shown in the drawings, and will be described in detail herein, specific embodiments of the present invention, with the understanding that the present disclosure is to be considered an exemplification of the principles of the invention, and is not intended to limit the invention to that as illustrated and described herein.

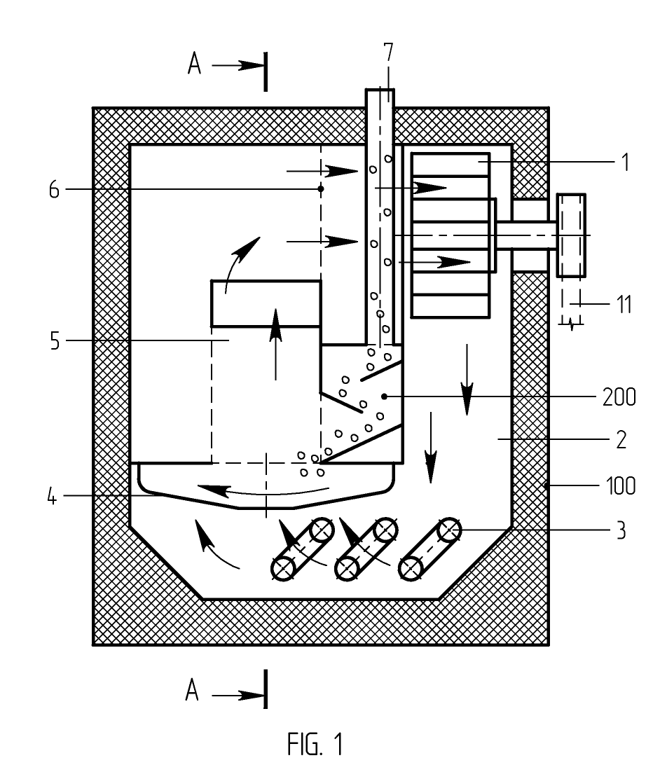

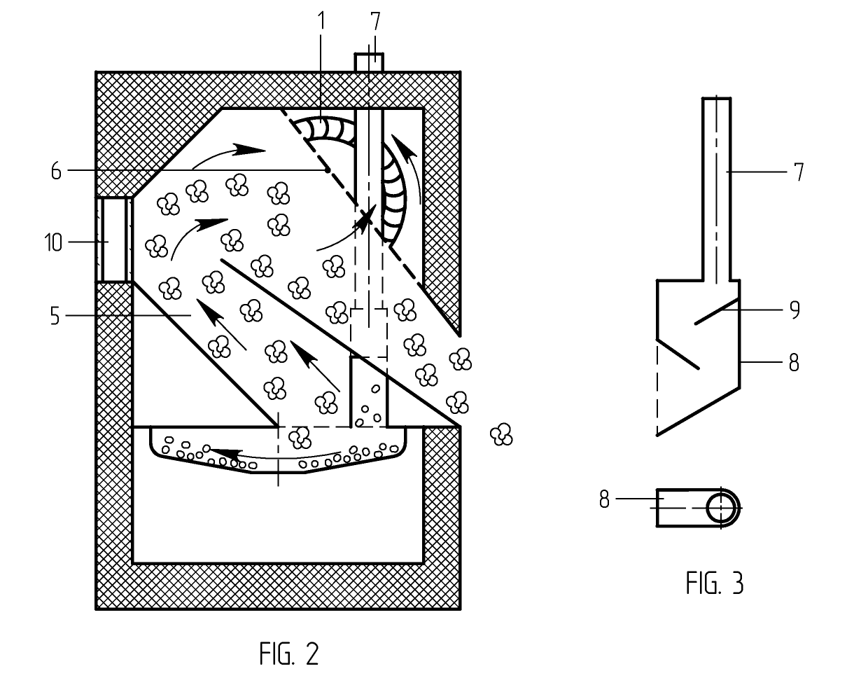

In a preferred embodiment, illustrated on FIGS. 1 and 2, the inventive popcorn making machine includes a main unit 100, comprising: a case 2; a fan 1 driven by a drive 11 (that may preferably include an electric motor—not shown, and a transmission, for example, a belt transmission); the fan 1 is capable of pumping air via a net screen 6 inside the case 2 with a top lid and a bottom, which case 2 encloses a cooking roaster 4 (can also be called a ‘kettle’ or a ‘cooker’), and a heater 3 that can be represented by any suitable type of conventional heater, preferably an electric coil outwardly surrounding the roaster's sidewalls (as shown on FIG. 1), and powered preferably from a suitable electrical source, not shown herein, preferably supplying controllable voltage. The heater 3 is preferably mounted at the case's bottom, beneath the roaster 4. The net screen 6 prevents getting popped up corn kernels to the fan 1.

The roaster 4 has a bottom, and sidewalls that can be tapered downwardly (i.e. shaped as a bowl, similar to that of U.S. Pat. No. 8,276,504), or the sidewalls can have a different suitable shape. The sidewalls are preferably furnished with mini-nozzles (not shown) attached to the internal surface of sidewalls. The mini-nozzles can be attached to the bottom of roaster 4 as well. The mini-nozzles may have a shape described in U.S. Pat. No. 8,276,504, or another similar shape, suitable for creation of a circulated airflow within the roaster 4. Thusly, hot airflows are introduced from the case 2, preferably through the mini-nozzles, into the roaster 4 tangentially to the inner surface of its sidewalls, thereby forming a hot airflow circulation within the roaster 4. Raw corn kernels, effected by the hot airflow circulation, are heated up faster and evenly. Optionally, the hot airflow circulation can be provided not necessarily by mini-nozzles, but by other means capable of creating such hot airflow circulation.

The main unit 100 comprises a feeding pipe 7 supplying raw corn kernels into the roaster 4. The feeding pipe 7 is mounted preferably vertically in the top lid for intake of raw corn kernels and further introducing thereof substantially into the interior space of case 2. Thus, the feeding pipe 7 has an upper aperture situated above the top lid, through which the raw corn kernels are fed into, and a lower aperture. The corn kernels could, however, get into the narrow feeding pipe, pop up therein, thereby block the incoming raw corn flow, and interrupt the process of making popcorn. This problem is solved by the instant invention as follows below.

The main unit 100 comprises a trap 200 for corn intake control. The trap 200, shown on FIGS. 1, and 3-5, is a vessel with an upper entrance and a lower exit. The trap 200 has a bottom that is preferably declined at a predetermined angle, as shown on FIGS. 3-5. The trap is mounted within the interior of case 2. The upper entrance of trap 200 is coupled with the lower aperture of feeding pipe 7, from which raw corn moves into the trap 200. The lower exit of trap 200 is situated above the roaster 4, through which lower exit the roaster 4 receives raw corn kernels from the trap 200. The lower exit of trap 200 should preferably be represented by a vertical rectangular opening at the bottom of trap 200.

As shown on FIGS. 1 and 3, the trap 200 comprises a trap body 8, having inner trap walls, and at least two blades 9 attached to the inner trap walls on opposite sides thereof, and inwardly declined at a predetermined angle from the inner trap walls. The lower blade 9 is preferably inwardly protruded from the inner wall to which it's attached, so that the lower blade 9 partially covers the lower exit of trap 200. Such arrangement of the blades 9 provides for an easy movement of raw corn kernels downward the trap, but prevents any movement of popped-up corn kernels from the roaster 4 upward the trap (those kernels that occasionally get into the lower part of trap 200 will fall down under the action of their own weight and pushed by the raw kernels falling down from the feeding pipe 7), which effectively prevents blocking the feeding pipe 7, and thereby helps controlling corn intake by the inventive popcorn making machine.

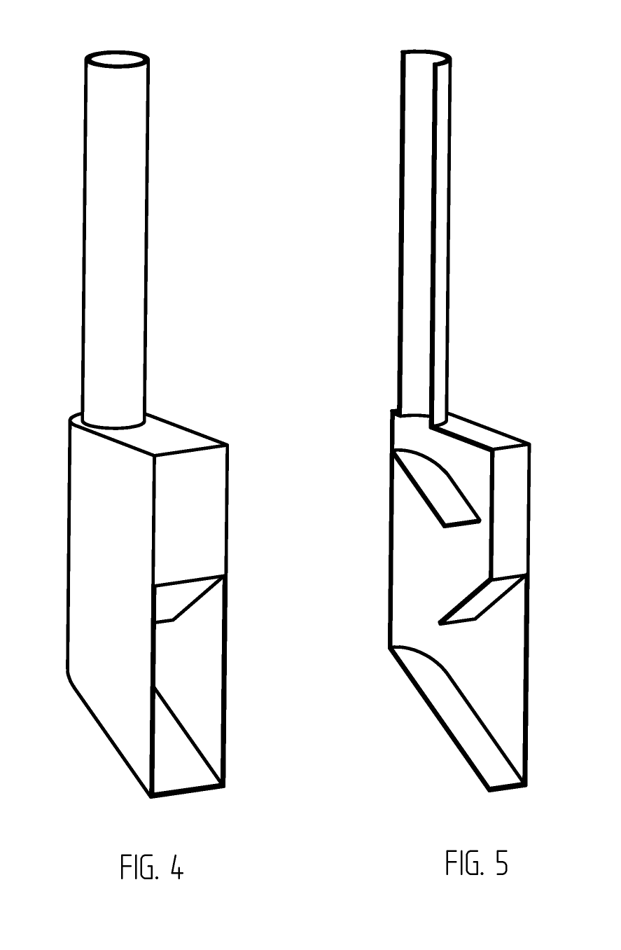

It is experimentally determined that the trap 200 should preferably be shaped as an upright prism (shown on FIGS. 4 and 5) having a width of 40 mm. A preferred height of attachment of the upper blade 9 to the inner walls is 100 mm.

The main unit 100 also comprises a pipebranch 5 including a first inclined branch receiving popped-up corn kernels from the cooking roaster 4, and a second inclined branch in a ‘knee’ -manner joined with the first inclined branch, through which second inclined branch the popped-up corn kernels are discharged from the main unit 100, as shown on FIG. 2. An optional transparent window 10, as shown on FIG. 2, can preferably be provided in the main unit 100, which allows observing the process of making popcorn.

### Operation of a Preferred Embodiment

The inventive popcorn making machine operates as follows: the fan 1, driven by the drive 11, pumps air via the net screen 6 out of the case 2 and draws it to the heater 3 that essentially heats up the roaster 4 (e.g. via the aforementioned mini-nozzles, or otherwise), wherein a hot airflow circulation is provided (shown on FIGS. 1 and 2 by arrows). Raw corn kernels are fed from the feeding pipe 7 into the trap 200 and therefrom into the roaster 4, wherein the corn kernels are popped up when reach respective conditions. The popped corn kernels, acquiring an increased volume, are becoming capable of being born by the circulated hot airflow in the roaster 4; thereby they are introduced into the pipebranch 5, and then are discharged therefrom for further utilization. As described above, the trap 200 prevents popped up corn kernels from getting into the feeding pipe 7, thereby effectively preventing the blockage thereof, which helps controlling corn intake by the inventive popcorn making machine.

### Optional Ramifications

As it was disclosed in U.S. Pat. No. 8,276,504: “In addition to the main unit 100, a preferred (combined) embodiment of the inventive popcorn making machine . . . may additionally comprise a coater unit . . . . The claimed popcorn making machine in alternative embodiments may comprise only the above described main unit 100 without any coater unit.” Likewise, the main unit 100 of the instant invention can also be optionally combined with the coater unit described in U.S. Pat. No. 8,276,504.

I claim:

1. A popcorn making machine comprising:
a case with a top lid, said case has an interior space enclosing a roaster, wherein a circulated hot airflow is provided;
a feeding pipe mounted in the top lid; said feeding pipe has an upper aperture situated above the top lid, wherein raw corn kernels are fed through said upper aperture into the feeding pipe; said feeding pipe has a lower aperture;
a trap for corn intake control, said trap is mounted within said interior space of the case;
said trap has an upper entrance for receiving raw corn and a lower exit for discharging raw corn into the roaster, wherein the upper entrance is coupled with said lower aperture;
wherein said trap comprises:
a body, having inner walls, and
at least two blades attached to the inner walls on opposite sides thereof, and inwardly declined at a predetermined angle from the inner walls; said at least two blades include a lower blade inwardly protruded from the corresponding inner wall and attached thereto, so that the lower blade partially covers said lower exit;
wherein said trap essentially prevents blocking the feeding pipe by corn kernels, and thereby helps controlling raw corn intake by the popcorn making machine.

2. The popcorn making machine according to claim 1, wherein said trap further comprises a bottom declined at a predetermined angle, and the lower exit is represented by a vertical rectangular opening at the bottom of said trap.

3. The popcorn making machine according to claim 1, wherein said trap is shaped as an upright prism having a width of 40 mm, and wherein said at least two blades further include an upper blade having a height of attachment to the corresponding inner wall of 100 mm.
